(19) United States
(12) Patent Application Publication
(10) Pub. No.: US 2007/0121821 A1
(43) Pub. Date: May 31, 2007

(54) System and Method for Displaying Ring Back Tone and Caller Display in Picture/Video Format

(76) Inventor: Chengchun Su, Shenzhen (CN)

Correspondence Address: GLOBAL IP SERVICES, 2462 ROCK ST., APT. 6, MOUNTAIN VIEW, CA, 94043, US

(21) Appl. No.: 11/562,642

(22) Filed: Nov. 22, 2006

(30) Foreign Application Priority Data
Nov. 23, 2005 (CN) 200510101851.6

(51) Int. Cl. H04M 11/00

(52) U.S. Cl. 379/88.13

(57) ABSTRACT

The present invention relates to a system and method for displaying Ring Back Tone and Caller Display in picture/video format, to solve the defect of the RBT in the prior art that can only provide a voice signal and cannot provide a picture or video signal. In the present invention, when originating a call, for the specific user, the switch of calling user/called user will select a corresponding picture/video file from a RBT/Caller Display server that coupled with a originating/receiving switching center, according to the personal setting of the calling/called user; then transmitting the file to a communication terminal of the calling/called user, and processing therein; then displaying related content on a screen, thus when a call is connected but not be answered, calling user can watch the picture/video preset by called user, and/or called user can watch the picture/video preset by calling user. The picture/video formatted RBT and Caller Display system of the present invention is an individual fashion like the CRBT, it is suitable for those who willing to go in for newness, fashion and personality users.

### CROSS REFERENCE TO RELATED PATENT APPLICATION

This patent application claims the priority benefit of a Chinese patent application No. 200510101851.6 filed on Nov. 23, 2005.

### BACKGROUND OF THE INVENTION

1. Field of the Invention

The present invention relates to a Ring Back Tone signal and Caller Display service, more particularly, relates to a system and method for displaying Ring Back Tone and Caller Display in picture/video format.

2. Description of the Related Art

Ring Back Tone (RBT) is the tone heard by the caller when the incoming call is reached to a receiver but not be answered. Traditional RBT is a discontinuous sound like “Do . . . Do . . . ”, and it is always the same tone and lacks of peculiarity. The popular Coloring Ring Back Tone (CRBT) nowadays can provide an individualized RBT service for user, and user can subscribe a personal tone according to his/her own favorite and requirement. The tone can be a piece of music, a song, an advertisement, or a voice recorded by the user. When calling the phone user who has applied CRBT service, the caller can hear the predetermined music or voice signal other than the traditional humdrum sound of “Do . . . Do . . . ”.

There are two kinds of technical solutions for the present CRBT service, one is based on an intellectual network, wherein the service logic is realized by applying the signaling control point (SCP) of a mobile intellectual network; the other technical solution is by amending switch, wherein by amending the devices in a Mobile Switching Center (MSC) of a network, such as changing calling flow, and then adding a CRBT platform to provide personal RBT and user management functions for consumers.

But, either traditional RBT or popular CRBT service only provides a voice RBT signal, and cannot provide picture or video RBT signal.

### SUMMARY OF THE INVENTION

One object of the present is to solve the defect of the prior art that the RBT is only a voice signal and cannot be a picture or video signal.

The technical solution of the present invention is to provide a method for displaying picture/video formatted Ring Back Tone accomplished by originating switch, wherein comprises the steps of:

(S11) for each call, estimating whether called user is a specific user based on called number by originating switch, if it is, specifically marking this call, and then sending this call to receiving switch;

(S12) establishing a connection between originating switch and a RBT/Caller Display server according to said specific mark, if the information returned by receiving switch shows the called user is idle, and selecting a corresponding picture/video file from the RBT/Caller Display server according to personal setting of the called user, and then transmitting the file to the calling terminal;

(S13) processing the received picture/video file by the calling terminal, and displaying the related content on a screen;

(S14) stop transmitting the picture/video file by originating switch after the called user answers the calling, and establishing a call connection between the calling terminal and called terminal.

In addition, the present invention also provides a method for displaying picture/video formatted RBT accomplished by a receiving switch, wherein comprising the steps of:

(S21) for each call, connecting originating switch with receiving switch directly;

(S22) returning the status information of called user from receiving switch to originating switch if the called user is in idle and estimating whether called user is a specific user at the same time based on called number, if it is, establishing a connection between receiving switch and a RBT/Caller Display server, and selecting a corresponding picture/video file from said server according to the personal setting of called user, then transmitting the file to calling terminal;

(S23) processing the received picture/video file by calling terminal, and displaying the related content on a screen;

(S24) stop transmitting the picture/video file by receiving switch after called user answers the calling, and then establishing a call connection between the calling and called terminals.

Preferably, for the above two methods, the RBT/Caller Display server can be the server that coupled with the home switching center of the called user, and also can be the server that coupled with the home switching center of the calling user; and in step (S12) or (S22), further comprising the step of, sending the tone signal back to calling terminal if the information returned by receiving switch shows called user is idle.

The present invention further provides a method for displaying picture/video formatted Caller Display accomplished by originating switch, wherein comprises the steps of:

(S31) for each call, estimating whether a calling user is a specific user by originating switch based on calling number, if it is, specifically marking this call, and sending this call to a receiving switch;

(S32) establishing a connection between originating switch and a RBT/Caller Display server according to the specific mark, if the information returned by receiving switch shows called user is idle; and selecting a corresponding picture/video file from the server according to the personal setting of calling user, then transmitting the file to a called terminal;

(S33) processing the received picture/video file by the called terminal, and displaying the related content on a screen;

(S34) stop transmitting the picture/video file by originating switch after called user answers the calling, and then establishing a call connection between the calling and called terminals.

In addition, the present invention further provides a method for displaying picture/video formatted caller display accomplished by a receiving switch, wherein comprising the steps of:

(S41) for each call, connecting originating switch with receiving switch directly;

(S42) returning the status information of called user from receiving switch to originating switch if called user is idle, and estimating whether the calling user is a specific user at the same time based on calling number, if it is, establishing a connection between receiving switch and a RBT/Caller Display server, and selecting a corresponding picture/video file from the server according to the personal setting of calling user, then transmitting the file to called terminal;

(S43) then processing the received picture/video file by the called terminal and displaying the related content on a screen;

(S44) stop transmitting the picture/video file by receiving switch after called user answers the calling, and then establishing a call connection between the calling and called terminals.

Preferably, for the above two methods, the RBT/Caller Display server can be the server that coupled with a home switching center of calling user, and also can be the server that coupled with a home switching center of called user.

Preferably, if the picture/video file involves video & audio information, the calling/called terminals will display the corresponding video content on the screen, and play the corresponding audio through a loudspeaker at the same time.

Furthermore, the present invention also provides a picture/video formatted RBT/Caller Display system which comprising at least one switch, each switch having at least one communication terminal; the system further comprising a RBT/Caller Display server coupled with a home switching center of the switch, a picture/video files database for storing and managing the user customized picture/video information is disposed in the RBT/Caller Display server; each switch can select a corresponding picture/video file from the RBT/Caller Display server that coupled with the home switching center of itself, or select the file from the RBT/Caller Display server that coupled with the home switching center of called user, according to the personal setting of calling user or called user, and then transmit the selected file to the calling or called terminal, thus to accomplish the function of picture/video formatted RBT/Caller Display.

Preferably, the switch is a fixed phone system switch or a mobile phone system switch; the communication terminal is a fixed phone or a mobile phone, and the most preferred terminal having a module to process the received picture/video file and display the related images on a screen, or play the audio content through a loudspeaker at the same time.

From the above mentioned technical solution, the picture/video formatted RBT and Caller Display system and method enables calling user not only can hear the traditional RBT or CBRT, but also can watch picture/video (picture/video formatted RBT) preset by called user, while waiting for the called user answering the call; on the other hand, the present invention also enables the terminal of called user not only display the phone number of calling user, but also the picture/video (picture/video formatted caller display) preset by calling user. And for entertainment purpose, the RBT or the call display can be a joke, a picture or self-taken picture, a flash, a MTV or a segment of film; for business purpose, the RBT or the call display can be a name of company, product, or an advertisement with various styles. The picture/video formatted RBT and Caller Display system is an individual fashion like the CRBT, it is suitable for those who willing to go in for newness, fashion and personality users.

### BRIEF DESCRIPTION OF THE DRAWINGS

The present invention will detail described in according with the drawings and preferred embodiments as below.

FIG. 1 illustrates one preferred embodiment of the compose of the picture/video formatted RBT/Caller Display system of the present invention;

FIG. 2 illustrates the flow of displaying the picture/video formatted Caller Display accomplished by originating switch;

FIG. 3 illustrates the flow of displaying the picture/video formatted Caller Display accomplished by receiving switch;

FIG. 4 illustrates the flow of displaying the picture/video formatted RBT accomplished by originating switch;

FIG. 5 illustrates the flow of displaying the picture/video formatted RBT accomplished by receiving switch.

### DETAILED DESCRIPTION OF THE INVENTION

The present invention disclosed a video RBT/Caller Display technology that applying to the communication terminal like a CRBT, it is a picture or video information that displayed on the terminal of calling user or called user, when a call is connected but not answered by the receiver. The detailed description of this invention is as follows.

A. Composing of the System

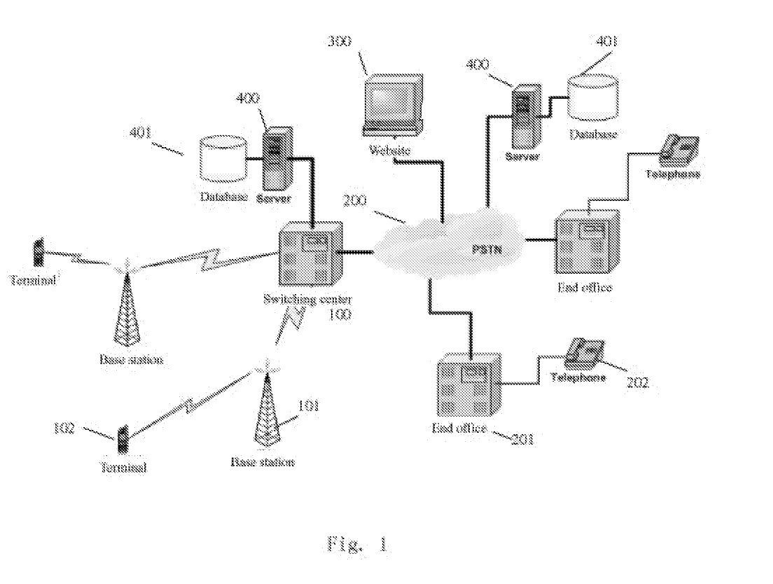

As shown in FIG. 1, in one preferred embodiment of the present invention, the picture/video formatted RBT/Caller Display system comprising a system website 300, a mobile switching center 100 and/or fixed phone network switching center 200, a mobile base station 101 and/or a fixed phone end office 201, a RBT/Caller Display server 400, a database 401 for picture/video files, and a fixed phone set 202 and/or mobile phone 102 acts as communication terminal.

1. System Website

In the present embodiment, the system website 300 can provide the services as follows.

1.1 Service Fulfillment/Cancellation

The user can sign on to the system website 300 to fulfill or cancel a service, for example, the present invention can be applied as one of the self-servicing item on the website of China Mobile (http://www.chinamobile.com/). Of course, the user can fulfill or cancel such a service in any service center of the telecommunication operator.

1.2 Presetting the Picture/Video

On the one hand, the system website 300 can provide a picture/video editor for users to edit words, images and other formatted files into picture/video formatted file; the system website 300 also receives uploaded picture/video files; then these files may be sent to and stored into the database 401 that belongs to a mobile phone switching center or fixed phone network switching center of a communication terminal.

On the other hand, users can customize a picture/video formatted Caller Display or RBT through the website, and customize a default picture/video or selectable picture/video.

1.2.1 The picture/video formatted RBT is similar with the prior CRBT, it is customized by a called user, and then the caller not only can hear the traditional RBT or personalized RBT, but also can watch the picture or video customized by called user, at the time when the call is connected but not be answered.

1.2.2 The picture/video formatted RBT Caller Display is customized by a calling user, it will be displayed on the terminal of called user when a call is connected but not be answered.

1.2.3 Default picture/video means when a call is made by a calling user to a called user, a preset picture/video will display on the terminal of the caller/receiver.

1.2.4 Selectable picture/video means when a call is made by a caller to a receiver, the caller/receiver can select a preset picture/video to display on the terminal. In order to customize a selectable picture/video formatted Caller Display, calling user need to add a specific number ahead of the called phone number. For example, if dial “*03*1234567890”, the called number is “1234567890”, and the picture/video numbered “03” that customized by calling user will be transmitted and sent to the terminal of called user. It is more complex to customize the picture/video formatted RBT, called user need to enter the phone number of calling number, then point a picture/video file that wish to appear to calling user, and then save this responding relation into the database for picture/video files 401; the preferred realization of the selectable picture/video formatted RBT is by a communication terminal which having a play module.

1.3 Online Dial

If a calling user sign on the system website 300 (such as sign on by its own phone number and password), and fill in the phone number of called user at the corresponding interface, then input the individualized picture or video, and click “initiating a call” or the similar button, a called user then be dialed online. The system website 300 will inform the mobile switching center or end office of the calling user or called user to establish the corresponding communication channel. At this point, the communication terminal of called user (phone set 202 or cell phone 102) will display the individualized picture or video that customized by calling user (i.e. the picture/video formatted Caller Display) besides the calling user's phone number, when it is ringing.

1.4 Downloadable Software Suite

The system website 300 of the present embodiment can provide toll or free software that matching with various types of terminals, to support for decoding the picture/video information.

2. RBT/Caller Display Server

As FIG. 1 showing, a RBT/Caller Display server 400 is directly coupled with the mobile phone switching center 100 or fixed phone network switching center 200 which has fulfilled this service; the database for picture/video files 401 of the RBT/Caller Display server 400 is used for storing and managing the picture/video information that customized by the user, and accepting the amendment information to the picture/video that comes from the system website 300 or the user's terminal.

When dialing a call, if the phone number of called user is a common one, at the time when the mobile switching center or end office of calling user establishing the connection with the mobile switching center or end office of called user, the RBT/Caller Display server 400 will search for the calling numbers to make sure whether it has customized a default picture/video Caller Display. And if the called number is not a common one, and a specific number is added ahead of the phone number, the RBT/Caller Display server will find out the corresponding picture/video file and waiting to be sent.

Once a connection is established between the calling and called users, the RBT/Caller Display server of called user will search for the number of the called users to make sure whether it has customized a default picture/video Caller Display, or search whether the calling number is listed in the list of the selectable picture/video RBT, if it is, the server will feed the corresponding picture/video file back to the mobile switching center or end office of calling user, and then send it to calling user; at the same time, the picture/video formatted Caller Display will display on the terminal of called user through the mobile switching center or end office, together with the caller information.

3. Communication Terminal

The communication terminal of the present embodiment can be the common phone set 202 or cell phone 102 in the prior art, and also can be the video phone set or cell phone having play module; the common phone set and cell phone can only customize the picture/video Caller Display through the system website 300, and can not receive picture/video formatted RBT.

For example, user can download a software suite from the system website to its own terminal. When the terminal receives a picture/video file, the software will decode the file, and drive the screen and loudspeaker to display the corresponding pictures or images and play the voice signals, once called user answers the calling, the terminal will exit from the playing status and switch to calling status.

If a cell phone or video phone itself having the play module, it will be more convenient. The play module actually is software suite, it can be integrated into the communication terminal by manufacturer; the play module can edit, receive and send the picture/video directly, and enable a user to customize the default RBT or picture/video formatted Caller Display, or set a picture/video formatted Caller Display by dial a specific number. In addition, by this play module, a user can directly enter the picture/video mode to edit or select the standby picture/video file, then dial the phone number, the mobile switching center or end office will identify and send the file automatically; furthermore, by this play module, a user can also edit its communication menu and designate a picture/video formatted RBT.

A. Work Flow

In the present invention, RBT/Caller Display server 400 is coupled with mobile switching center 100 or fixed phone switching center 200 by TUP (Telephone User Part in No. 7 signaling system) signaling interactive. The activating of picture/video formatted RBT/Caller Display service is achieved by configuring a trigger (which is a program stored in a telephone user's database and will be executed if certain event occurs) in the telephone user's database. During the call, once the mobile switching center or fixed phone end office detects this trigger has been setup, it will connect the call to the RBT/Caller Display server, and then the server will control and transmit the picture/video file.

1. Work Flow of the Picture/video formatted Caller Display

1.1 Conducted by Originating Switch

The work flow is showed in FIG. 2, when any user originate a call, originating switch (i.e., the fixed phone end office of calling user) will conduct picture/video formatted call identification, if calling user is specific user, this call will be specifically marked; then the call will be connected to receiving switch (i.e., the fixed phone end office of called user). If receiving switch returns an ACM (Address Complete Message, used for indicating that all the information for identifying called user's address have been received and including additional information, such as user idle information.) signaling and showing the status is idle, originating switch will then establish a connection with the RBT/Caller Display server which coupled with the home switching center of calling user, according to the specific mark; and once the connection is established, the RBT/Caller Display server will select the corresponding picture/video file according to the logic relation between the calling number and called number, and the file will be transmitted to receiving switch. And then receiving switch will send the file to the terminal of called user, then the terminal will decode the file and play or display such a picture/video.

If called user is a mobile phone user, once the mobile switching center received the incoming call, it will page called user by a BSS (Base Station System). If successfully paged, it will return an ACM signaling to originating switch.

Once originating switch receives the ANC (Answer Signal Charge) answer signal returned by receiving switch, it shows called user has answered this calling, the originating switch/receiving switch will disconnect with the RBT/Caller Display server, and establish a communication channel between the calling and called terminals.

Therein, (1) if calling user and called user belong to the same switching center, both of the customized information will be stored in a same RBT/Caller Display server; (2) if calling user and called user belong to different switching centers of a same operator (for example, centers located in different states), then the customized information of both parties may be stored in different RBT/Caller Display servers; (3) if calling user and called user belong to different operators, then the customized information of both parties will be stored in different RBT/Caller Display servers.

If calling user and called user correspond to different RBT/Caller Display servers, it is preferred to select the picture/video file from the RBT/Caller Display server that coupled with the home switching center of calling user, and transmit to called user's terminal. If different servers can share the customized information real time, also, it can select the picture/video file from the RBT/Caller Display server that coupled with the home switching center of called user, and transmit to called user's terminal.

1.2 Conducted by Receiving Switch

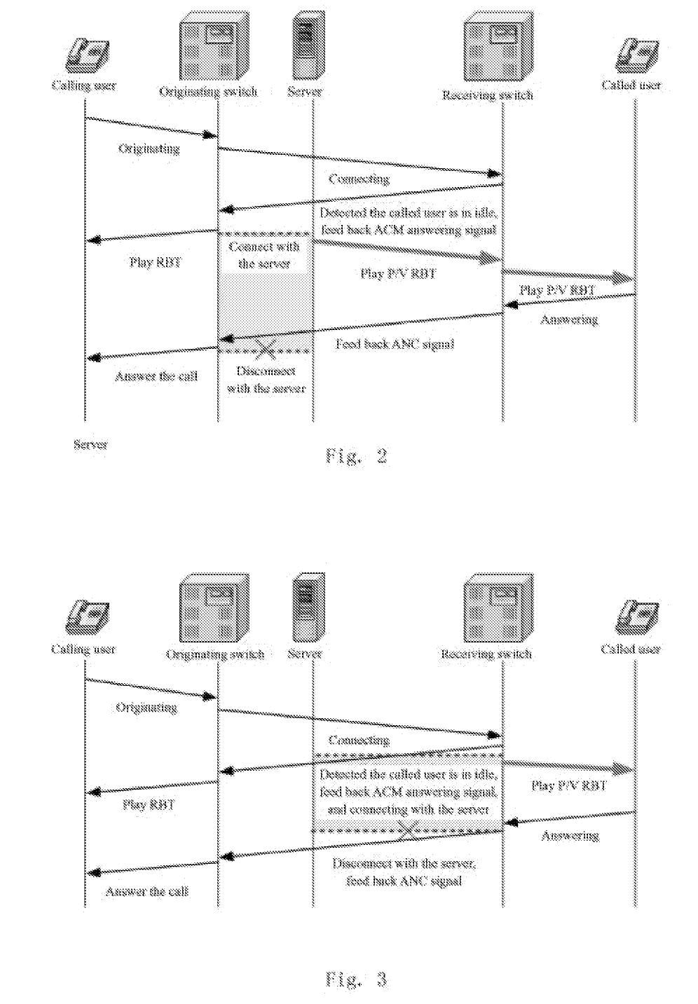

As shown in FIG. 3, when conducted by receiving switch, the call originated by originating switch is the same as the call originated by common user. If called user is idle, receiving switch will detect whether this call is a picture/video formatted call, if it is, it will establish a connection with the RBT/Caller Display server that coupled with the home switching center of calling user; once connected, the server will select the related picture/video file according to the logic relation between the calling and called numbers, and transmit this file to the terminal of called user, and return a ACM signaling to originating switch at the same time; if called user is a mobile phone user, once the MSC of called user receives an incoming call, it will page called user by a BSS, if successfully paged, it will return an ACM signaling to originating switch; and once called user answers, receiving switch will disconnect with the RBT/Caller Display server, and return an answer signal to originating switch at the same time, and establish a communication channel between the calling and called terminals. At this point, if the flow is conducted by originating switch, originating switch will accomplish mode identification; and if the flow is conducted by receiving switch, receiving switch will accomplish mode identification.

2. Work Flow of the Picture/Video Formatted RBT

2.1 Conducted by Originating Switch

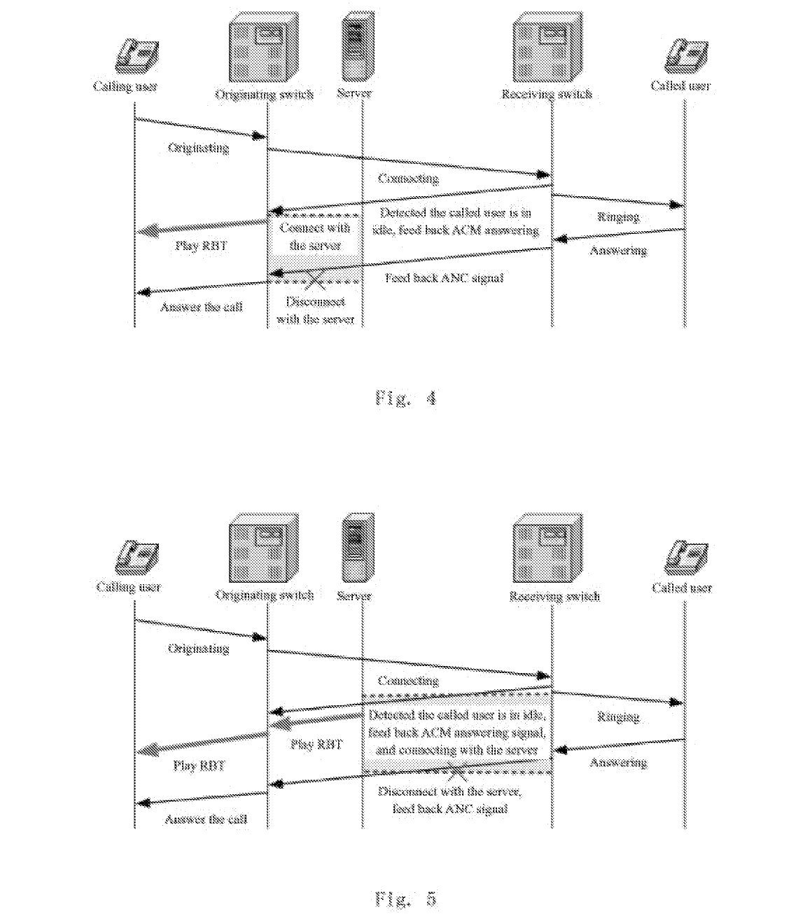

As shown in FIG. 4, when calling user originates a call, originating switch will identify called number, if the number belongs to a specific user, this call will be specifically marked and connected to receiving switch. If receiving switch returns an ACM signaling and showing the status is idle, originating switch will then establish a connection with the RBT/Caller Display server which coupled with the home switching center of called user, according to the specific mark; and once the connection is established, the RBT/Caller Display server will select the corresponding picture/video file according to the logic relation between the calling number and called number, then transmit the file to the terminal of calling user. Once originating switch receives the returned ANC answer signal, it will disconnect with the RBT/Caller Display server, and establish a communication channel between the calling and called terminals. And, when transmitting the picture/video file, the traditional RBT or CRBT also can be transmitted to the terminal of calling user; if the picture/video file is in video & audio format, the RBT will be suppressed and only the picture/video file will be sent.

Also, as if calling user and called user correspond to different RBT/Caller Display servers separately, it is better for the server that coupled with the switching center of called user to select the picture/video file, and send it to the terminal of calling user. And if each server can share the customized information, it is possible for the server that coupled with the switching center of calling user to select the picture/video file, and send it to the terminal of calling user.

2.2 Conducted by Receiving Switch

As shown in FIG. 5, when conducted by receiving switch, the call originated by originating switch is the same as the call originated by common user. If called user is idle, receiving switch will return an ACM signaling to originating switch (if called user is a mobile phone user, once the MSC of called user receives an incoming call, it will page called user by a BSS, if successfully paged, it will return an ACM signaling to originating switch); and at the same time, receiving switch will detect whether called number belongs to a specific user, if it does, a connection with the RBT/Caller Display server that coupled with the switching center of called user will established; after connected the server, the server will select a corresponding picture/video file according to the logic relation between the calling and called numbers, and transmit the file to the terminal of calling user. Once called user answers, receiving switch will disconnect with the RBT/Caller Display server, and return an answer signal to originating switch at the same time, then establish a communication channel between the calling and called users.

Wherein, if calling user has fulfilled the service of picture/video formatted Caller Display, and called user has fulfilled the service of picture/video formatted RBT, then the system can play the related picture/video to calling user and called user separately.

If the devices of the system encounter problems, the system will instruct to skip the picture/video formatted RBT/Caller Display flow, and conduct a normal ring, caller display or RBT, to avoid any obstacle in calling.

What is claimed is:

1. A method for displaying picture/video formatted Ring Back Tone accomplished by originating switch comprising the steps:
for each call, estimating whether a called user is a specific user by originating switch based on called number, if it is, specifically marking this calling, and sending this calling to a receiving switch;
establishing a connection between originating switch and a RBT/Caller Display server according to the specific mark, if the information returned by receiving switch shows called user is idle; and selecting a corresponding picture/video file from the RBT/Caller Display server according to personal setting of called user, then transmitting the file to calling terminal;
processing the received picture/video file by calling terminal, and displaying the related content on a screen;
stop transmitting the picture/video file by originating switch after called user answers the calling, and establishing a call connection between the calling and called terminals.

2. The method of claim 1, wherein the RBT/Caller Display server is a server coupled with the home switching center of called user, or a server coupled with the home switching center of calling user.

3. The method of claim 1, wherein in the step of establishing a connection, further comprising a step of sending the tone signal back to calling terminal if the information returned by receiving switch shows called user is idle.

4. The method of claim 1, wherein in the step of processing the file, when the picture/video file is a video & audio file, the terminal of calling user will displaying the related video on the screen, and playing the related audio through a loudspeaker at the same time.

5. A method for displaying picture/video formatted RBT accomplished by a receiving switch comprising the steps:
for each call, connecting originating switch with receiving switch directly;
returning the status information of called user from receiving switch to originating switch if called user is idle, and estimating whether called user is a specific user at the same time based on called number, if it is, establishing a connection between receiving switch and a RBT/Caller Display server, and selecting a corresponding picture/video file from the server according to the personal setting of called user, then transmitting the file to calling terminal;
processing the received picture/video file by calling terminal, and displaying the related content on a screen;
stop transmitting the picture/video file by receiving switch after called user answers the calling, and then establishing a call connection between the calling and called terminals.

6. The method of claim 5, wherein the RBT/Caller Display server is a server coupled with the home switching center of called user, or a server coupled with the home switching center of calling user.

7. The method of claim 5, wherein in the step of establishing a connection, further comprising a step of sending the tone signal back to calling terminal if the information returned by receiving switch shows called user is idle.

8. The method of claim 5, wherein in the step of processing the file, if the picture/video file is a video & audio file, the terminal of calling user will display the related video on the screen, and play the related audio through a loudspeaker at the same time.

9. A method for displaying picture/video formatted Caller Display accomplished by originating switch comprising the steps:
for each call, estimating whether a calling user is a specific user by originating switch based on calling number, if it is, specifically marking this calling, and sending this calling to a receiving switch;
establishing a connection between originating switch and a RBT/Caller Display server according to the specific mark, if the information returned by receiving switch shows called user is idle; and selecting a corresponding picture/video file from the server according to the personal setting of calling user, then transmitting the file to a called terminal;
processing the received picture/video file by the called terminal, and displaying the related content on a screen;
stop transmitting the picture/video file by originating switch after called user answers the calling, and then establishing a call connection between the calling and called terminals.

10. The method of claim 9, wherein the RBT/Caller Display server is a server coupled with the home switching center of calling user, or a server coupled with the home switching center of called user.

11. The method of claim 9, wherein in the step of processing the file, if the picture/video file is a video & audio file, the terminal of called user will display the related video on the screen, and play the related audio through a loudspeaker at the same time.

12. A method for displaying picture/video formatted caller display accomplished by a receiving switch comprising the steps of:
for each call, connecting originating switch with receiving switch directly;
returning the status information of called user from receiving switch to originating switch if called user is idle, and estimating whether the calling user is a specific user at the same time based on calling number, if it is, establishing a connection between receiving switch and a RBT/Caller Display server, and selecting a corresponding picture/video file from the server according to the personal setting of calling user, then transmitting the file to called terminal;
then processing the received picture/video file by the called terminal and displaying the related content on a screen;
stop transmitting the picture/video file by receiving switch after called user answers the calling, and then establishing a call connection between the calling and called terminals.

13. The method of claim 12, wherein the RBT/Caller Display server is a server coupled with the home switching center of calling user, or a server coupled with the home switching center of called user.

14. The method of claim 12, wherein in the step of processing the file, if the picture/video file is a video & audio file, the terminal of called user will display the related video on the screen, and play the related audio through a loudspeaker at the same time.

15. A picture/video formatted RBT/Caller Display system comprising:
at least one switch, each switch having at least one communication terminal;
the system further comprising a RBT/Caller Display server coupled with the home switching center of the switch, a picture/video files database for storing and managing the user customized picture/video information is disposed in the RBT/Caller Display server;
each switch can select a corresponding picture/video file from the RBT/Caller Display server that coupled with the home switching center of itself, or select the file from the RBT/Caller Display server that coupled with the home switching center of called user, according to the personal setting of calling user or called user, and then transmitting the selected file to the calling or called terminal, thus to accomplish the function of picture/video formatted RBT/Caller Display.

16. The picture/video formatted RBT/Caller Display system of claim 15, wherein said switch is a fixed phone system switch or a mobile phone system switch.

17. The picture/video formatted RBT/Caller Display system of claim 15, wherein said terminal is a fixed phone or a mobile phone that having a module to process the received picture/video file and display the related images on a screen, or play the related audio content through a loudspeaker at the same time.
